(19) United States
(12) Patent Application Publication
(10) Pub. No.: US 2018/0157725 A1
(43) Pub. Date: Jun. 7, 2018

(54) Query-Based Application Data Retrieval

(71) Applicant: Big Fish Games, Inc., Seattle, WA (US)

(72) Inventor: Charles Benjamin Flynn, Seattle, WA (US)

(73) Assignee: Big Fish Games, Inc.

(21) Appl. No.: 15/367,056

(22) Filed: Dec. 1, 2016

(51) Int. Cl. G06F 17/30; A63F 13/35

(52) U.S. Cl. CPC G06F 17/30569; A63F 13/35; G06F 17/30477; G06F 17/30283

(57) ABSTRACT

A server device may desire to obtain information relating to customer interaction with an application residing on customer devices. To obtain the information, the server device may transmit a query to multiple customer devices that include the application. As a customer interacts with the application via a customer device, the customer device may store application data that represents the customer interaction. The customer device may identify data events within the application data that satisfy at least one query criteria associated with the query. The customer device may transmit, to the server device, the one or more data events. Based on the one or more data events, the server device may determine interests or preferences of the customer with respect to the application. The server device may modify the application with respect to the customer device based at least partly on the interests or preferences of the customer.

### BACKGROUND

With the increasing use of mobile devices, such as mobile telephones, tablet devices, electronic book (eBook) reader devices, etc., consumers are frequently accessing and interacting with applications that reside on corresponding mobile devices. Such applications may allow consumers to play games, obtain various types of information (e.g., weather, politics, stock market updates, sports, etc.), shop for items, interact with social networks, and so on. A source of a particular application (e.g., a service provider) may desire to obtain information about how consumers interact with the application. As a result, the source may cause the mobile devices to transmit large amounts of data to a server for further processing. However, transmitting large amounts of data from the mobile device to the server for storage by the server may cause multiple technical problems. For instance, transmitting large amounts of data may cause the mobile device to experience drain on its battery life and the network used to transmit the data may become constrained, resulting in a reduction in network bandwidth. Moreover, storage of the data by the server may require a large amount of memory/storage, which may not be available, and analyzing the data may require a significant amount of processing power by the server.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system for determining data events relating to an application associated with a customer device.

FIG. 2 is diagram showing an example customer device that stores application data relating to an application and a mapping table used to determine data events from the application data.

FIG. 3 is a diagram showing an example system for determining data events associated with an application residing on a customer device based on a query initiated by a server device.

FIG. 4 is a diagram showing an example system for sending, to a customer device, a query for data events relating to an application residing on the customer device.

FIG. 5 is a flow diagram showing an example process of receiving data events relating to an application residing on a customer device.

FIG. 6 is a flow diagram showing an example process of determining data events relating to an application residing on a customer device based on a query initiated by a server device.

### DETAILED DESCRIPTION

This disclosure describes systems and processes for determining data events associated with an application residing on customer devices of customers, and based on a query initiated by a server computer. In particular, customers may interact with applications (or games) via corresponding customer devices, such as by downloading the applications to the customer devices or otherwise accessing, or interacting with, the applications via the customer devices. An entity associated with the application may desire to obtain information regarding how customers interact with the application, and an extent to which customers interact with the application (e.g., number of interactions, frequency of interactions, etc.). For instance, the entity may desire to obtain information about certain events or sequence of events, but the entity may not be interested in other customer interactions. In existing systems, all of (or a significant portion of) the data that represents customer interaction with the application may be transmitted from the customer devices to a server device associated with the entity. Although some of the data may indicate meaningful customer interactions with the application, most of the data may not be of particular interest to the entity, and transmitting, storing, and/or processing large amounts of data is likely to cause various technical problems.

As a result, the systems and processes described herein may request and receive, from the customer devices, specific types of data that represents customer interaction with the application. More particularly, a customer device may store various types of data relating to an application or a game that resides on the customer device, and the data may represent user interaction with the application or game. The data may be stored in memory of the customer device in an optimized binary format, which may indicate various types of information about the data. For instance, such information may include an identifier, a timestamp, and/or one or more values that represent characters, application/game events, scenes, etc., regarding the application data. Due to the customer device storing the data in a pre-optimized binary format, the customer device may record and store a large number of events and/or user interactions associated with the application/game.

In some embodiments, an entity associated with the application/game, such as a service provider, may desire to obtain specific information relating to customer consumption and/or interaction with the application/game. For instance, the service provider may desire to determine the extent to which customers interacted with a certain player, chose to access a particular level, performed a certain action/operation, and so on. As a result, the service provider may generate a query that requests the desired information/data. The query may include criteria that specifies the type of information requested, and may be transmitted to one or more customer devices of customers that have downloaded and/or accessed the application/game. Upon receiving the query, the customer device may search the application/game data stored thereon to determine if any data/events satisfy the criteria included in the query. If so, the customer device may send, via a network, the data/events to the server device of the service provider. If not, the customer device may either indicate that no data/events responsive to the criteria were found, or not respond to the query altogether. The service provider may then analyze/process the data/events provided by the customer device(s) in order to determine how customers are interacting with the application/game, which may allow the service provider to determine interest and/or preferences of customers with respect to the application. Based on the interests/preferences of customers, the service provider may elect to modify the application in some manner.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

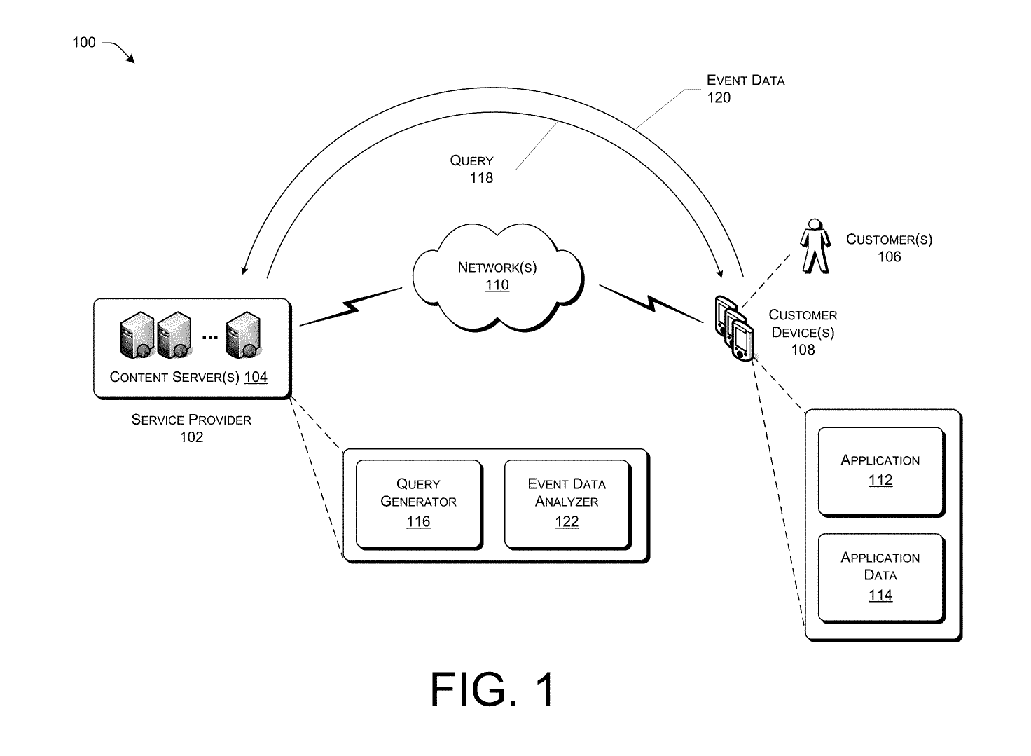

FIG. 1 illustrates a system 100 in which a service provider may send queries for data/events stored on customer devices of customers, where the data/events relate to customer interaction with an application/game that resides on the customer devices, and the customer device(s) return data/events that are responsive to the queries. As shown, the system 100 may include a service provider 102, one or more content servers 104 associated with the service provider 102, one or more customers 106, one or more customer devices 108 associated with the customers 106, and one or more networks 110.

In certain embodiments, the service provider 102 may be an entity that enables the customers 106 to access, interact with, consume, play, etc., one or more applications 112 via corresponding customer devices 108. For instance, the service provider 102 may maintain the applications 112 such that the applications 112 may be downloaded/transferred to, and subsequently installed/stored on, the customer devices 108. In this embodiment, an application 112 may be stored in memory of customer devices 108 of customers 106 that download/install the application(s) 112. Once downloaded/installed, the customers 106 may access the application 112 via his/her customer device(s) 108. In other embodiments, the customers 106 may access, interact with, consume, play, etc., the application(s) 112 via the network(s) 110, such that the application(s) 112 are not actually stored on the customer devices 108. The service provider 102 may also provide access to the application(s) 112 on behalf of another entity, such as an entity that manufactures, distributes, and/or sells the application(s) 112.

In some embodiments, the service provider 102 may offer items (e.g., products, services, games, mobile applications 112, etc.) to the customers 106 via an electronic marketplace (e.g., a website, a mobile application 112, etc.) associated with the service provider 102. That is, the customers 106 may access the electronic marketplace via corresponding customer devices 108 for the purpose of searching for, viewing, selecting, acquiring (e.g., purchasing, leasing, renting, borrowing, lending, etc.), etc., items. The items may be provided directly by the service provider 102, or may be provided by the service provider 102 on behalf of a different entity, such as one or more merchants. That is, via a web site, an electronic marketplace, and/or a mobile application 112 associated with the service provider 102, the customers 106 may place orders for items to be provided by the service provider 102 and/or the merchants.

Moreover, the customers 106 (also referred to herein as “users” and/or “consumers”) may include any person or entity that interacts with the service provider 102 for the purpose of ordering, acquiring, purchasing, etc., items from the service provider 102, and possibly on behalf of the merchants. The customers 106 may interact with the service provider 102 via corresponding customer devices 108, which may include cellular/mobile telephones, tablet devices, laptop computers, desktop computers, gaming consoles, electronic book (eBook) reader devices, virtual reality headsets, a personal digital assistant (PDA), a multi-functioning communication device, and so on. In some embodiments, as opposed to the customer 106 being an individual person, the customer 106 may correspond to an entity or group, such as a company, a corporation, an educational institution, a non-profit entity, a religious institution (e.g., a church), an athletic team, and so on.

In various embodiments, the customer devices 108 may have input device(s) such as a keyboard, a mouse, a pen, a voice input device, a touch input device, etc. The customer device 108 may also include one or more displays and other output device(s), such as speakers, a printer, etc. The customer 106 may utilize the foregoing features to interact with the customer device 108 and/or the content server(s) 104 via the network(s) 110. More particularly, a display of the user device 104 may include any type of display known in the art that is configured to present (e.g., display) information to the customer 106. For instance, the display may be a screen or user interface that allows the customer 106 to access, play, and/or download the applications 112. The customer devices 108 may also include any number of speakers that audibly present content to the customers 106 and/or microphones that capture sound (e.g., voice commands, ambient noise, etc.).

As described herein, a customer 106 may view, search for, acquire (e.g., purchase, lease, rent, borrow, etc.) one or more applications 112 via the service provider 102. The application(s) 112 may be downloaded to customer devices 108 of the customers 106 such that the customers 106 may access, interact with, consume, play, etc., the applications 112. The customers 106 may access the applications 112 over the network 110, such as the Internet, which may be communicatively coupled to the one or more content server(s) 104 associated with a service provider 102. The network(s) 110 may facilitate communications and/or interactions between the content server(s) 104 of the service provider 102 and the customer devices 108. The network(s) 110 may facilitate such communications/interactions via any type of network 110, such as a public wide-area-network (WAN) (e.g., the Internet), which may utilize various different technologies including wired and wireless technologies. Moreover, the content servers 104 may contain any number of servers that are possibly arranged as a server farm. Other server architectures may also be used to implement the content servers 104.

The content server(s) 104 may store various types of applications 112, games (e.g., software games, etc.), and other content that is accessible by the customer devices 108 (e.g., media content, audio content, video content, etc.). Moreover, the content server(s) 104 and/or the customer device(s) 108 may include one or more processors, computer-readable media (e.g., memory), and one or more modules/components. The processor(s) may execute the one or more modules/components and/or processes to cause the content server(s) 104 and/or the customer device(s) 108 to perform a variety of functions, as set forth above and explained in further detail in the following disclosure. In some embodiments, the processor(s) may include a central processing unit (CPU), a graphics processing unit (GPU), both CPU and GPU, or other processing units or components known in the art. Additionally, each of the processor(s) may possess its own local memory, which also may store program modules, program data, and/or one or more operating systems.

The computer-readable media may include volatile memory (such as RAM), non-volatile memory (such as ROM, flash memory, miniature hard drive, memory card, or the like), or some combination thereof. The computer-readable media may be non-transitory computer-readable media. The computer-readable media may include, or be associated with the one or more modules/components that perform various operations associated with the content server(s) 104 and/or the customer device(s) 108. In some embodiments, the one or more modules/components may include or be associated with computer-executable instructions that are stored by the computer-readable media and that are executable by the processor(s) to perform such operations. The content server(s) 104 and/or the customer device(s) 108 may also include additional modules/components not listed above that may perform any function associated with the content server(s) 104 and/or the customer device(s) 108.

For the purpose of this discussion, an application 112 may be a mobile application, which is a software application designed to operate/run on the customer devices 108. The applications 112 may be pre-installed on the customer devices 108 (e.g., pre-installed software) and/or downloaded by customers 106 to the customer devices 108. The applications 112 may present any type of information to a customer 106. Examples of an application 112 may include a web browser, an e-mail client, a calendar, a mapping program, a social network, mobile banking, a news source (e.g., politics, sports, weather, etc.), applications 112 used to search for information (e.g., restaurants, etc.), an application 112 used to track physical activity, an application 112 for consuming media content (e.g., music, videos, eBooks, audio books, etc.), and/or applications 112 used to view, search for, obtain information about, and/or acquire items (e.g., physical items, digital items, games, etc.). In certain embodiments, the application 112 may be a game, such as a game of chance, a casual game, an online game, a software game, and/or any other type of game that is accessible and playable via the customer devices 108. A customer 106 may open and/or interact with the application 112 using an input mechanism associated with a customer device 108, such as by interacting with a touch-sensitive display, actuating a button or joystick, uttering a voice command, and so on. Once the customer 106 has opened/initiated the application 112, the customer 106 may navigate between pages, tabs, screens, etc., of the application 112 for the purpose of obtaining information, communicating with individuals/entities, searching for, viewing, and/or acquiring items, and so on.

As stated above, the application 112 may be any type of game that may be played by the customer 106 via his/her customer device. Games of chance may refer to games in which the outcome is at least partly random or is influenced at least in part by a randomizing device. In games of chance, the players may elect to wager real or virtual currency, or anything of monetary value, prior to at least a portion of the game being played (e.g., spinning a set of reels). Examples of games of chance may include physical games, games played via a network 110, or games played via a user device 104, such as dice games, spinning tops, playing cards, slot machines, roulette wheels, and many other casino games. A game of chance may have some skill element, although the chance or randomness of the game may play a greater role in determining the outcome of the game. In other games of chance, a certain degree of skill may enhance a player's performance with respect to the game. This may be the case where the player(s) make game decisions based upon previous or incomplete knowledge, such as in various casino or card games (e.g., blackjack, poker, etc.).

Casual games may include games (e.g., video games) that are associated with any type of gameplay and any type of genre. Casual games may have a set of simple rules that allow a large audience to play, such as games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices (e.g., mobile telephone, tablet devices, etc.), etc., and may be played online via a web browser. Casual games may be referred to as “casual” since the games may be directed towards consumers who can come across the game and get into gameplay in a short amount of time, if not immediately. Examples of casual games may include puzzle games, hidden object games, adventure games, strategy games, arcade and action games, word and trivia games, casino games, and/or card and board games.

Customers 106 may access the applications 112/games in any of a number of different manners. For instance, the customers 106 may access a site (e.g., a website) associated with an entity, such as the service provider 102 or a merchant, that provides access to the games. Such a site may be remote from the customer device 108 but may allow the customers 106 to interact with the games via the network(s) 110. Moreover, the customers 106 may download/install the one or more applications 112 to the customer device 108 in order to access the games, such that the customer 108 is able to play the game via an application 112. In this case, the content server(s) 104 (via the service provider 102) may provide, transmit, suggest, and/or recommend the games to the customer device 108, whereby the customers 106 may interact with the games via the downloaded application(s) 112. In other embodiments, the games may be streamed from the content server(s) 104 via the service provider 102 to the customer device 108 such that the customers 106 may interact with the games in real-time (or near real-time). Once the customer 106 accesses the games, the customer 106 may perform a variety of actions, including learning about the games, viewing the games, trying the games, acquiring (e.g., purchasing, renting, leasing, etc.) the games, downloading/installing the games to the customer device 108, and/or playing the games.

Additionally, the customers 106 may have a user account or user profile associated with the service provider 102, which provides access to, and allows for the downloading of, the applications 112. For instance, assuming that the applications 112 are available via a website, each of the customers 106 may have a user account or user profile that specifies various types of information relating to the customers 106. This information may include personal information, user preferences, and/or some user identifier (ID), which may be some combination of characters (e.g., name, number, etc.) that uniquely identifies the customer 106 from other customers 106.

Provided that an application 112 is stored on, or is at least is accessible via, a customer device 108 of a customer 106, the customer device 108 may store application data 114 relating to the application 112. In particular, as the customer 106 is interacting with the application 112, the customer device 108 may store application data 114 that represents those customer interactions with the application 112. Each customer interaction with the application 112 may be represented by a particular data event stored within the application data 114. Such interactions may include the customer 106 accessing the application 112 and/or the customer 106 performing one or more operations with respect to the application 112 via the customer device 108. The operations or actions performed by the customer 106 with respect to the application 112 may include opening/initiating the application 112, opening/sending an e-mail message, creating a calendar event, purchasing an item, viewing a post/image or creating post/message via a social network, or any other action performed by the customer 106 while the customer 106 is accessing the application 112 via the customer device 108. If the application 112 is a game, or if the customer 106 is accessing the application 112 to play a game, the operation/action may be any game move by the customer 106 with respect to the game. Such game moves may include moving or interacting with a character/player, entering a scene/level, attaining a reward (e.g., points, tokens, badges, etc.), matching tiles, removing a hazard, and so on. That is, the application data 114 may include any information or data events that represents the customer 106 interacting with the application 112.

As stated in additional detail herein, the application data 114 may be stored in memory/computer-readable media of the customer device 108. In some embodiments, the application data 114 may be stored in RAM and then copied, either periodically or upon request, to storage media associated with the customer device 108. The application data 114 may be stored in any format, such as a textual format or a binary format. Moreover, each portion of application data 114 stored by the customer device 108 may include one or more bytes that indicate information about that portion of application data 114. For the purpose of this discussion, individual portions of the application data 114 may be referred to herein as a “data event.” That is, a data event may correspond to information/data relating to a customer interaction with the application 112. Provided that the application data 114 is stored in a binary format, large amounts of application data 114 may be stored/maintained by the memory of the customer device 108. By hashing (e.g., applying a hash function to) the application data in the binary format, by causing the customer device 108 to store specific application data 114 relating to the application 112, and/or by hashing strings to a limited number of bytes, the amount of data stored by the customer device 108 may be decreased significantly.

Moreover, when application data 114 is transmitted from the customer device 108 to the content server 104, the application data 114 may include, or be accompanied with, contextual information. The contextual information may include a customer identifier of the customer 106 associated with the customer device 108, a customer device identifier of the customer device 108, identification of the operating system of the customer device 108, screen resolution information associated with the customer device 108, embedded software development kits (SDKs) associated with the customer device 108, and so on. The content server 104 may desire this information to determine a context of the application data 114 relating to the application 112, which may include the customer 106/customer device 108 associated with the application data 114. However, when the application data 114 is stored on the customer device 108, such contextual information may not be needed, or at least a reduced amount of the contextual information is stored in associated with the application data 114. That is, the customer device 108 may be aware of the context of the application data 114. Accordingly, the amount of storage needed to store the application data 114 on the customer device 108 may be reduced.

In various embodiments, the content server(s) 104 of the service provider 102 may include a query generator 116. The query generator 116 may generate queries 118 that are sent to customer devices 108 and that request various types of application data 114. For instance, the service provider 102 may desire to obtain information about the extent to which customers 106 interact with a certain character of a game. This may include instances in which the customer 106 opened/interacted with the application 112, a duration of the interactions, a frequency of the interactions, particular operations/actions taken with respect to the application 112, and so on. As a result, the query generator 116 may generate a query 118 that requests application data 114 (data events) that are responsive to the query 118. That is, the query 118 may include criteria (also referred to herein as “query criteria”) that specifies that the customer devices 108 are to provide event data 120/data events that are representative of customers 106 interacting with that particular character via the game. Upon identifying such event data 120/data events within the application data 114, the customer device(s) 108 that received the query 118 may transmit the event data 120/data events to the content server(s) 104 via the network(s) 110. An event data analyzer 122 of the content server(s) 104 may then analyze/process the event data 120 to determine the extent to which a certain customer interaction with respect to the application 112 has occurred. As a result, the content server(s) 104 may determine which features/characteristics of the application 112/game that customers 106 like/dislike, which may allow the content server(s) 104 to make modifications to the application 112/game based on previously determined preferences, interests, etc., of customers 106.

In addition to the event data analyzer 122 analyzing and/or processing the event data 120, the customer device 108 may analyze and/or process the application data 114, including data events included within the application data 114. The analysis/process performed by the customer device 108 may be dependent upon the particular query 118 (or the scope of the query 118) transmitted to, and received by, the customer device 108. In particular, if the query 118 requests a specific type of data event included within the application data 114 stored on the customer device 108, the customer device 108 may analyze/process the application data 114 in order to identify instances/data events that satisfy the criteria 118. As an example, assume that the query 118 sent by the content server(s) 104 stated that “If the customer primary has used character X, and spends an average of Y in-game currency per session, send a response in the affirmative.” Upon receiving such a query 118, the customer device 108 may analyze/process the application data 114 to identify instances/data events that satisfied that query 118. The customer device 108 may then provide such information to the content server(s) 104. Further analysis/process may then be performed by the content server(s) 104, or direct action may be performed with respect to the application 112 (e.g., presentation of situational/specific advertising via the application 112, application 112/game modifications, etc.).

Accordingly, instead of the customer device 108 transmitting all of the application data 114/data events to the content server(s) 104, the content server(s) 104 may instead request specific event data 120/data events included within the application data 114 from the customer device(s) 108 via one or more queries 118. The customer devices 108 may search the application data 114 stored in its memory to determine which portions of the application data 114 (e.g., data events) satisfy the criteria associated with the one or more queries 118. Moreover, the customer devices 108 may send event data 120/data events that are responsive to the one or more queries 118, without having to send all of the application data 114. In turn, the service provider 102 may receive, from customer devices 108, the event data 120/data events that are of particular interest. In additional embodiments, the customer device 108 may send, to the content server(s) 104, data that is representative of the event data 120/data events. For instance, the customer device 108 may send an average of the data events, a summation of the data events, and/or apply one or more mathematical functions to the data events and then send the resulting data to the content server(s) 104.

The systems and processes described herein provide multiple technical advantages for the content server(s) 104 and the customer devices 108. For instance, if the customer devices 108 were to transmit all, or a significant portion of, the application data 114 relating to the application 112, the customer device 108 would experience considerable battery drain. That is, it would take a significant amount of power and/or battery life to transmit a large amount of data (e.g., all of the application data 114) from the customer device 108 to the content server(s) 104 over a network 110. Compromising battery life of the customer device 108 may cause an inability of the customer device 108 to perform other operations. Since specific requested event data 120/data events may instead be transmitted from the customer device 108 to the content server(s) 104, the battery life of the customer device 108 may not be compromised. Moreover, transmitting such large volumes of data may compete with other operations being performed by the customer device 108. That is, if transmitting the application data 114 is prioritized, the customer device 108 may be unable to perform other high priority operations that are essential for the proper functioning of the customer device 108. Transmitting large amounts of data/information may also prevent the customer device 108 from being able to transmit other information to different sources. Since the customer device 108 may only provide event data 120/data events associated with the application 112 upon request, the customer device 108 may devote its resources (e.g., battery, CPU, etc.) to performing other operations that are intended for the normal/customary operation of the customer device 108.

In additional embodiments, transmitting large volumes of data, such as the application data 114, may cause network bandwidth problems. That is, by one or more customer devices 108 continuously and/or simultaneously transmitting large volumes of data (e.g., the application data 114/data events) using the network(s) 110, the network(s) 110 may have reduced bandwidth to transmit other data/information. This may especially be the case when potentially hundreds, thousands, or millions of customer devices 108 are simultaneously transmitting data/information to the content server(s) 104. Limited network bandwidth associated with the network(s) 110 may prevent some information/data from being transmitted between devices, and may cause data/information to transmitted, uploaded, and/or downloaded at reduced rates, possibly resulting in performance issues. Transmitting large amounts of data may also result in data packet loss. Accordingly, only transmitting certain event data 120/data events of the application data 114 that are responsive to one or more queries 118 sent by the content server(s) 104 may reduce network traffic associated with a network 110 that is used to transmit such information.

In other embodiments, if the customer devices 108 were to transmit all of the application data 114 relating to an application 112 to the content server(s) 104, the content server(s) 104 would have to store and process/analyze the application data 114 in order to identify data events that are of particular interest. The content server(s) 104 requesting and receiving only a portion of the application data 114 may result in reduced server-side storage associated with the content server(s) 104, which may allow the content server(s) 104 to store additional/different data/information. Moreover, only processing/analyzing data events requested by the content server(s) 104 (via the one or more queries 118) may reduce server-side requirements for processing data/information. This may cause additional CPU, memory, and other resources to be available for other operations to be performed by the content server(s) 104.

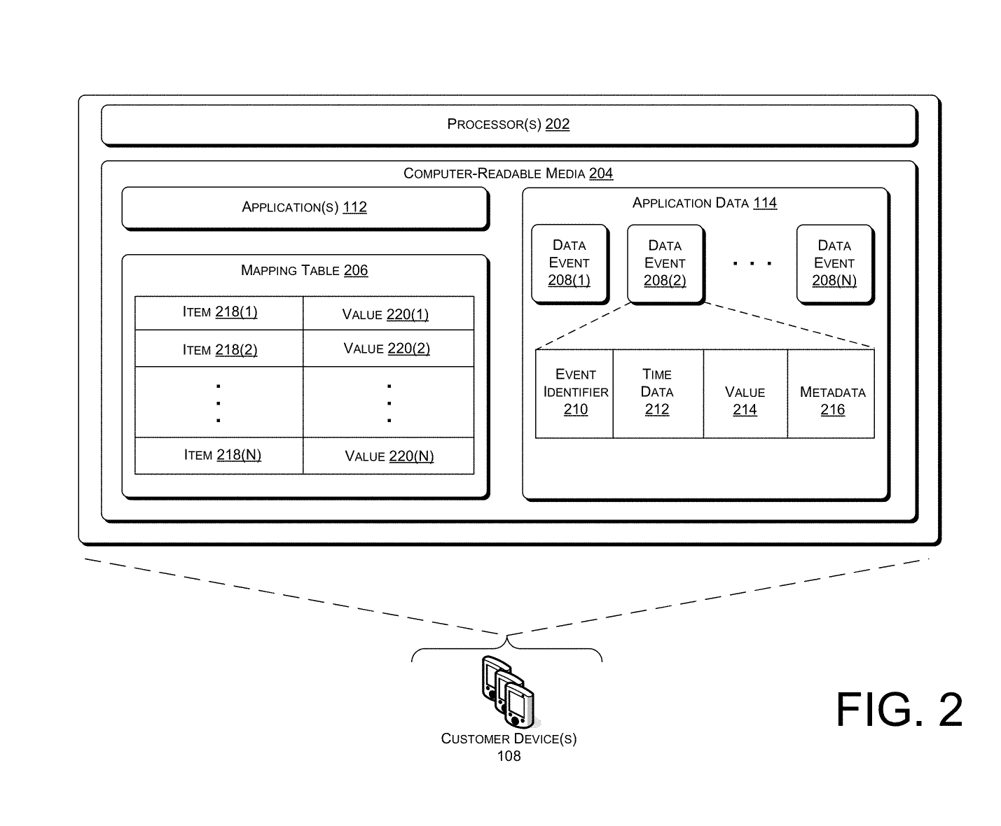

FIG. 2 illustrates an example customer device 108 that is included in the system 100 of FIG. 1. In various embodiments, the customer device 108 may include one or more processor(s) 202 and computer-readable media 204, which is described with respect to FIG. 1. As shown in FIG. 2, the computer-readable media 204 may include (or store) the one or more applications 112, the application data 114 that is associated with the application(s) 112, and a mapping table 206. For the purpose of this discussion, the application(s) 112 and the application data 114 are similar to that described with respect to FIG. 1. For instance, the application data 114 may be data, information, events, etc., that represent customer interaction with the application(s) 112. More particularly, the customer device 108 may create and store a data event 208 each time the customer 106 performs an action/operation with respect to the application 112.

As shown, the application data 114 may include any number of data events 208, which are represented by data event 208(1), data event 208(2), and data event 208(N), and which each represent a different operation/action performed by the customer 106 with respect to the application 112. For instance, a first data event 208 may correspond to the customer 106 viewing or purchasing an item via the application 112, a second data event 208 may represent the customer 106 consuming media content (e.g., a video, a song, etc.) via the application 112, and/or a third data event 208 may correspond to the customer 106 performing a game event with respect to a game being played via the application 112, such as by moving or interacting with a character, entering a scene, reaching a certain level, earning a reward/points, and so on. Each of the individual data events 208 may be stored in the computer-readable media 204 of the customer device 108 in an optimized binary format. In some embodiments, the data events 208 may be compressed prior to storage on the customer device 108. Each data event 208 may include, or be associated with, a series of bytes that include one or more of an event identifier 210, time data 212, a value 214, and metadata 216 (also referred to herein as “meta-information”). For the purposes of illustration, such information is displayed with respect to data event 208(2).

In various embodiments, the event identifier 210 may include any sequence of characters, numbers, symbols, string (e.g., a UTF8 string), images, etc., that uniquely identifies the data event 208(2), and possibly the customer interaction that is represented by the data event 208(2). As set forth below, the event identifiers 210 may be stored in the mapping table 206, and the event identifiers 210 may be associated with a unique number/integer within the mapping table 206. This unique number/integer may be stored in the data event 208 itself. As a result, the customer device 108 may compress the data stored thereon without compromising the uniqueness of the numbers/integers. Moreover, the time data 212 may indicate a time at which the data event 208(2)/customer interaction occurred. For instance, the time data 212 may include a timestamp, which may be measured using any time interval (e.g., 10ths of seconds). The timestamp may correspond to the particular time at which the data event 208(2) occurred, which may correspond to the time of the customer interaction with the customer device 108. If the data event 208(2) was not instantaneous and instead is associated with a duration of time, the duration of time may be stored in association with the data event 208(2). For instance, for a session end event, the timestamp associated with that data event 208(2) may correspond to the moment the session ended, where the timestamp may be included within the time data 212. The duration of the session may be stored in association with the value associated with the data event 208(2). The time data 212 may also include a time interval that indicates an amount of time corresponding to the data event 208(2), such as a first time at which the data event 208(2) began and a second time at which the data event 208(2) ended. Moreover, the value 214 may correspond to a numerical value or character that represents an item (e.g., a character, scene, action, etc.) that is associated with the data event 208(2). In some embodiments, the value 214 may be obtained or derived from the mapping table 206. Provided that a string value is stored in the value 214 field, a hash function may be applied to the string value in order to generate an integer, which may then be stored in the value 214 field. In other embodiments, the string value itself may be stored in the value 214 field.

In various embodiments, the mapping table 206 may list items associated with the application 112 and corresponding values that are representative of (or associated with) those items. As shown, the mapping table 206 may include multiple items that are each associated with a corresponding value. Here, item 218(1) corresponds to value 220(1), item 218(2) corresponds to value 220(2), and item 218(N) corresponds to value 220(N). Each of the items may be hashed by the customer device 108 in order to determine their corresponding numerical values. That is, the customer device 108 may apply a hash function to an item to determine/generate a corresponding numerical value. If the data event 208(2) is associated with a particular item that is included in the mapping table 206, the customer device 108 may identify the value that corresponds to that item. Accordingly, the mapping table 206 may be stored on (or is at least accessible by) the customer device 108 and may map certain items (e.g., characters, levels, scenes, etc.) with a corresponding value 214. More particularly, the mapping table 206 may associate event names with consecutive (e.g., ascending) numerical keys/integers/key values, such that a first event name associated with the application 112 is associated with “1”, a second event name associated with the application 112 is associated with “2”, and so on. For instance, the event name “session start” may have a key value of “1”. When the customer device 108 searches the application data 114 for “session start”, possibly in response to a query 118 from the content server(s) 104, the customer device 108 compares the value 214 field for the number “1”. Accordingly, the mapping table 206 maps event names to unique ascending integers and data events 208 contain the integers. When the content server(s) 104 generates/writes the query 118, the content server(s) 104 may use the event name. Upon receiving the query 118, the customer device 108 may translate the event name to a number/integer using the associations contained within the mapping table 206.

In some embodiments, the customer device may store arbitrary key value pairs, so the customer device 108 may store a separate table to map/associate those key value pairs. For example, if storage within the customer device 108 is full or nearly full, the customer device 108 may store summary data of items that are to be discarded/purchased/deleted. More particularly, if the customer device 108 is to discard a certain number (e.g., 500) of session start events, the customer device 108 may store summary data that corresponds to the session start events that are to be discarded (e.g., “session start count”→500). The customer device 108 may also store an indication that criteria associated with a conditional query has been satisfied. For instance, if a particular conditional query is to “tell me when the user has spent $20 in the game”, the customer device 108 may run/execute that conditional query after each purchase until the condition associated with the conditional criteria has been satisfied. At that point, the customer device 108 may store an indication that the conditional query and/or the condition has been completed, and the customer device 108 cease to run/execute that conditional query.

Then, when the content server 104 generates a query 118 for specific information included in the application data 114, the query 118 may include the appropriate value 214 (and possibly the event identifier 212), which may be used to identify the requested data event 208 included in the application data 114. In particular, if the query 118 is looking up data events 208 by name, then they are translated via the mapping table 206. That is, the mapping table 206 may be utilized to determine the value associated with the data events 208. However, if the query 118 is looking up data events 208 by a corresponding value, and provided that the value is a string, then the string is hashed and the query 118 searches for the hash value of the string. Moreover, the metadata 216 may include meta-information about the data event 208(2), such as the payload of the data event 208(2) (e.g., whether the data event 208(2) has a payload of one or two bytes) and/or the potential payload of the data event 208(2) (e.g., whether the event has a potential payload of one or two bytes).

As an illustrative example, provided that the application 112 is a game being played by a customer 106 via a customer device 108, the data event 208(2) included within the application data 114 may correspond to the customer 106 placing the character “Willow” in a dungeon. In this example, the event identifier 210 may be “Willow dungeon” and the time data 212 may include a time (e.g., a timestamp) at which the customer 106 performed the game move that caused Willow to be placed in the dungeon. In other embodiments, the event identifier 210 may include “enter-dungeon_Willow”, so that customer device 108 is able to search for all “enter-dungeon” data events 208 by matching string prefixes. Or, the event identifier 210 may be “enter-dungeon” and the value 214 may be “Willow”. In this scenario, the look-up may be “enter-dungeon,” which may map to event identifier 210 “1”, and so that the customer device 108 may search for all incidents in which the customer 106 placed a character, including “Willow”, in the dungeon. In particular, if four bytes of storage are used for the value 214, an Adler32 hash/checksum may be used on “Willow”, which would translate the value 214 to “0866027f”. With respect to the game, the mapping table 206 may include at least “Willow” and “dungeon,” where “Willow” is hashed to create the value 214 “1” and “dungeon” is hashed to create the value 214 “2”, although other characters, scenes, levels, etc., associated with the game may also be included within the mapping table 206. Accordingly, the value 214 may include a “1” and/or a “2”. Moreover, the metadata 216 may include any other information relating to the data event 208, such as the payload and/or the expected payload associated with the data event 208.

Accordingly, if the service provider 102 desired to determine the extent to which customers 106 playing the game have placed Willow in the dungeon (e.g., the number of times, the frequency, etc.), the service provider 102 may generate a query 118 that requests such information. The query 118 may be sent to customer devices 108 that have downloaded the game, and may include criteria that specifies which data events 208 satisfy the query 118. In this example, the query 118 may indicate an appropriate event identifier 210, a timeframe in which the data event 208 is to occur, values corresponding to the requested event, and so on.

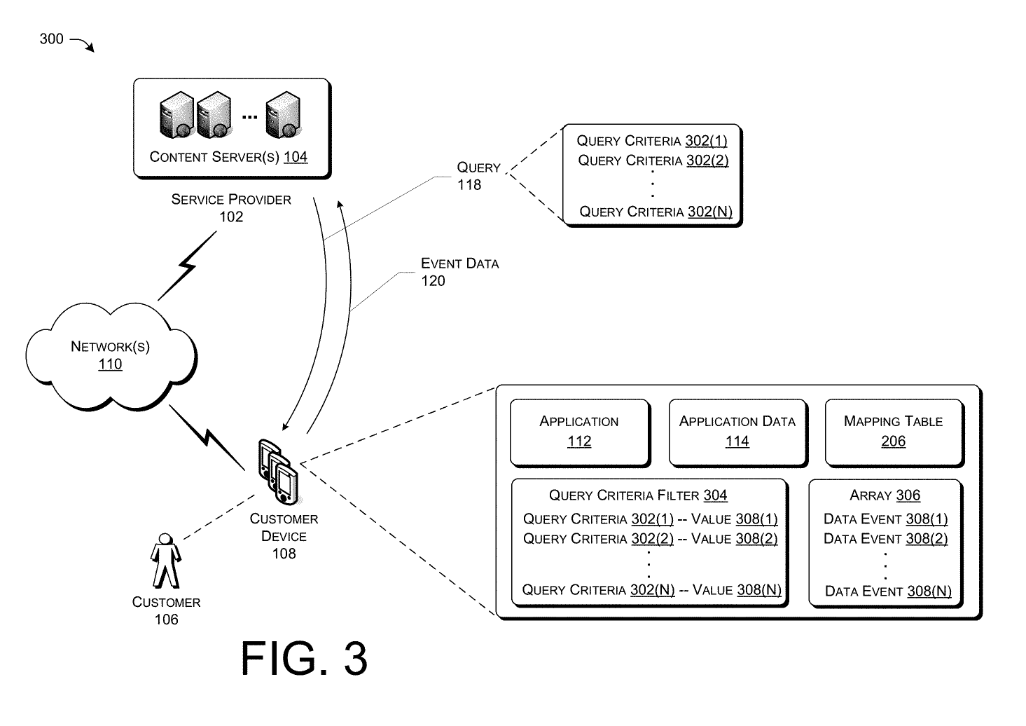

FIG. 3 illustrates a system 300 for determining event data associated with an application residing on a customer device based at least partly on a query transmitted by a server device. More particularly, the system 300 includes the service provider 102, the content server(s) 104, a customer 106, a corresponding customer device 108, and one or more networks 110.

As stated herein, the service provider 102 may desire to obtain information regarding customer interaction with an application 112/game that resides on customer devices 108. As a customer 106 interacts with the application 112 via his/her customer device 108, the customer device 108 may store application data 114 that represents such customer interactions. The application data 114 may include any number of data events 208 that each represent a different interaction with the application 112. In order to obtain the desired information, the content server(s) 104 of the service provider 102 may generate a query 118 that requests the desired information/data. The query 118 may be in a scripted language (e.g., JavaScript) that is transmitted from the content server(s) 104 to the customer device 108 via the network(s) 110.

In various embodiments, the query 118 may include any number of query criteria 302, which may be represented by query criteria 302(1), query criteria 302(2), and query criteria 302(N). The query criteria 302 may indicate conditions that specify what constitutes data events 208 that are responsive to the query 118. That is, since the query 118 requests specific application data 114 from the customer device 108, the query criteria 302 may be conditions that have to be satisfied in order for data events 208 included within the application data 114 to qualify as event data 120 that is to be transmitted back to the content server(s) 104. Using the example described with respect to FIG. 2, the query criteria 302 may include instances in which a customer 106 placed Willow in the dungeon in the past 30 days. In this example, a first query criteria 302 could be “30 days”, a second query criteria 302 could be the character “Willow”, and a third query criteria 302 could be “enter dungeon”. By specifying query criteria 302 that is associated with the query 118, the customer device 108 may determine which application data 114/data events stored thereon is actually responsive to the query 118.

Upon generating the query 118, the content server(s) 104 may transmit the query 118 to any customer device 108 in which that particular event associated with the application 112 may have occurred. For the purposes of FIG. 3, a single customer device 108 is shown, although the query 118 may be transmitted to any number of customer devices 108. As illustrated in FIG. 3, the customer device 108 associated with the customer 106 may include or store the application 112, application data 114 associated with the application 112, the mapping table 206 illustrated in FIG. 2, a query criteria filter 304, and an array 306. As stated above, the application 112 resides in memory of the customer device 108 and the application data 114 is collected and stored by the customer device 108 as the customer 106 interacts with the application 112. Individual portions of the application data 114 (i.e., data events 208) represent customer interactions with the application 112 at a particular time. Moreover, the mapping table 206 may map items or features associated with the application 112 with a different value, which may be determined by applying a hash function to the item/feature.

In various embodiments, the customer device 108 may receive the query 118 from the content server(s) 104. Upon receiving the query 118, the customer device 108 may generate, maintain, and/or update a query criteria filter 304 that specifies the query criteria 302 included in the query 118 and that is used to identify application data 114/data events that are responsive to the query 118. The query criteria filter 304 may be a table or matrix that is stored in memory of the customer device 106, or that is otherwise accessible by the customer device 108 (e.g., from the content server(s) 104, a different entity, etc.). For instance, the query criteria filter 304 may list the query criteria 302 included within the query 118 and associate a different value 308 for each of the query criteria 302. In some embodiments, the customer device 108 may utilize the mapping table 206 to determine the values 308 that correspond to the query criteria 302. As shown in FIG. 3, the query criteria filter 304 may include query criteria 302(1) and corresponding value 308(1), query criteria 302(2) and corresponding value 308(2), and query criteria 302(N) and corresponding value 308(N). The customer device 108 may determine items/features included within the query criteria 302, identify those items/features within the mapping table 206, determine the values 308 that correspond to those items/features, and then associate the query criteria 302 with the appropriate values 308.

For instance, using the example listed above, assume that the query 118 is requesting that customer devices 108 return event data 120/data events that corresponds to instances in which customers 106 placed the character “Willow” in the dungeon in the last 30 days. In this scenario, the query criteria 302 associated with the query 118 may be “Willow”, “enter dungeon”, and “30 days”. The customer device 108 may analyze the query criteria 302 to extract features/items that may be included in the mapping table 206. Upon identifying such terms in the mapping table 206, the customer device 108 may determine the corresponding values 308 and associate those values 308 with the query criteria 302 included within the query criteria filter 304. Then, the query criteria filter 304 may process the application data 114 to identify data events 308 (also referred to herein as “log events”) that satisfy each of the query criteria 302. For instance, the customer device 108 may search the application data 114 to identify instances in which the customer 106, by way of the application 112, placed “Willow” in the dungeon within the last 30 days. Instances in which each of the query criteria 302 was satisfied may be referred to data events 308. Each instance in which the customer 106 performed an action that satisfies the query criteria 302 may be included in the array 306. Accordingly, the array 306 may list the data events 308 (e.g., data event 308(1), data event 308(2), data event 308(N), etc.) that satisfied the query criteria 302, where each data event 308 represents an instance in which the query criteria 302 was satisfied. For instance, each data event 308 listed in the array 306 may represent an instance in which the customer 106 placed the character “Willow” in the dungeon within the last 30 days. In certain embodiments, the array 306 may include a count or summation of the data events 308 that are responsive to the query 118, and may include additional information relating to the data events 308, such as a time at which the data event 308 occurred, a customer device identifier corresponding to the customer device 108 that was used in association with the data event 308, a customer identifier corresponding to the customer 106 that performed the operation associated with the data event 308, and so on.

In certain embodiments, not all of the query criteria 302 associated with the query 118 need to be found in order for a data event 308 to be identified and stored in the array 306. For instance, if a single one of the query criteria 302 is satisfied, then a data event 308 may be identified and stored in the array 306. In addition, the query criteria filter 304 may list the query criteria 302 in the alternative, meaning that only one of the query criteria 302 has to be satisfied in order for a data event 308/log event to be found. For instance, using the example described herein, for the query 118 relating to instances in which customers 106 have placed the character “Willow” in the dungeon, the query criteria 302 “Willow” and “enter dungeon” may be in the alternative. Accordingly, first instances in which a customer 106 has either interacted with the character “Willow,” such as by placing “Willow” in the dungeon or performed any other action with respect to “Willow”, or second instances in which the customer 106 has placed any character (possibly including “Willow”) in the dungeon may qualify as a data event 308 that is responsive to the query 118.

In certain embodiments, logic associated with the customer device 108 may perform the operation of identifying data events 308 that are responsive to the query criteria 302 associated with the query 118. The logic may be computer/software code that is downloaded/installed with the application 112 at a time at which the application 112 is downloaded/installed to the customer device 108. The logic/code may begin executing when the application 112 is downloaded/installed on the customer device 108. Then, when the customer device 108 receives a query 118 from the content server(s) 104, the logic may cause the query 118 to run on the customer device 108 in a background or low-priority thread, such that executing the query 118 may not interfere with other operations/threads that are performed by the processor(s) 202 of the customer device 108, and that may be necessary for the proper functioning of the customer device 108.

Moreover, the customer device 108 may determine the data events 308 without first receiving a query 118 from the content server(s) 104. For instance, the application 112 may be programmed such that certain customer interactions are logged and stored as data events 308, or the logic described above may cause the customer device 108 to log and store such data events 308. The data events 308 may only include a portion of the application data 114 stored by the customer device 108. As a result, the customer device 108 may periodically send the event data 120 (or summary information/data corresponding to the event data 120) to the content server(s) 104, either at specified times, predetermined intervals, or upon a request to send appropriate event data 120. The summary information/data may include aggregate numbers, counts, summations, statistics, etc., associated with the identified data events 308 included within the event data 120.

After identifying data events 308 within the application data 114 that satisfy the query criteria 302, the customer device 108 may transmit the event data 120 to the content server(s) 104 via the network(s) 110. For the purposes of this discussion, the event data 120 may constitute each of the data events 308 that were determined to satisfy the query criteria 302 associated with the query 118. Moreover, the event data 120 may include the customer identifier and/or the customer device identifier associated with the customer 106/customer device 108 that performed the operations that caused generation of the data events 308 included within the event data 120. However, in some instances, the application data 114 stored on the customer device 108 may not include any data events 308 that satisfy the query criteria 302. As a result, the application data 114 may not contain any data events 308 that are responsive to the query 118. In that case, the customer device 108 may not transmit a notification/message to the content server(s) 104, or the customer device 108 may transmit a notification/message indicating that no data events 308 responsive to the query 118/query criteria 302 have been identified.

By sending the same query 118 to multiple customer devices 108 that have/store the application 112, the service provider 102 may determine the extent to which customers 106 are performing operations with respect to the application 112 that satisfy the query criteria 302 associated with the query 118. For instance, the service provider 102 may determine how many customers 106 have placed the character “Willow” in the dungeon within the last 30 days, and the frequency in which those customers 106 have performed that action. The service provider 102 may determine this based on the event data 120 that is returned to the content server(s) 104 by the customer devices 108 in response to the query 118. In additional embodiments, for customer devices 108 that have returned data events 308 responsive to the query 118, the content server(s) 104 may also request that those customer devices 108 store and transmit subsequent instances of that data event 308 occurring. For instance for a customer device 108 that transmitted data events 308 that were found to be responsive to the query 118, the customer device 108 may subsequently transmit additional data events 308 that are also responsive to that query 118. In addition to the foregoing, the service provider 102 may obtain and record other information associated with the event data 120. For instance, the service provider 102 may determine the number or percentage of customers 106/customer devices 108 that returned event data 120 responsive to the query 118, times in which the query 118 is active, the nature of the payload to be reported to the content server(s) 104 provided that customer devices 108 provide event data 120 that is responsive to the query 118, and so on. For instance, if the query 118 is “Report the amount and/or variance of in-game currency and cumulative session time of customers who have had Willow enter the dungeon at least 50 times”, the customer device 108 may provide event data 120 (or summary information/data corresponding to the event data 120) that includes data events 208 that are responsive to the query 118. The service provider 102 may then compare the currency amount reflected in the event data 120 to that of the average customer 106 in order to determine if customers 106 that interact with/use Willow at a higher frequency are earning/using more in-game currency as compared to the average customer 106.

In some embodiments, a customer 106 may have multiple customer devices 108, such as a mobile telephone, a tablet computing device, a laptop computer, an eBook reader device, and so on. In this scenario, multiple of the customer devices 108 may include the same application 112 (e.g., a game, a social network application 112, etc.), and the customer 106 may interact with the application 112 using different ones of the customer devices 108 at different times. As a result, if the service provider 102 sends a query 118 to just one of the customer devices 108, the event data 120 returned from that customer device 108 may be representative of the customer's 106 interaction with the application 112 using that particular customer device, but may not be representative of the customer's 106 overall interaction with the application 112. That is, the customer 106 may interact with the application 112 using other customer devices 108 that did not receive the query 118 and/or that did not send event data 120 in the event the customer device 108 did in fact receive the query 118.

Accordingly, the content server(s) 104 may send the query 118 to multiple customer devices 108 that are associated with the customer 106 and that include or store the application 112. As described above, each customer device 108 that receives the query 118 may identify data events 308 that are responsive to the query criteria 302 associated with the query 118. Each of the customer devices 108 may then send the event data 120 that includes the data events 308 and that each represents a particular customer interaction with the application 112. Moreover, the event data 120 provided by each customer device 108 may also be associated with a customer identifier of the customer 106. Accordingly, the event data 120 from each customer device 108 associated with the customer identifier may then be summed/aggregated to determine the total number of data events 308 that are associated with the customer 106 and that are responsive to the query 118. The summed/aggregated data events 308 may indicate the total number of customer interactions of the customer 106 with respect to the application 112 that satisfied the query criteria 302 of the query 118.

Moreover, in the multi-device embodiment in which a customer 106 accesses the same application 112 using multiple customer devices 108, summary and aggregate event data may be transmitted to a cloud-based resource (e.g., a server), and processed using a cloud-based key-value store associated with the cloud-based resource. For example, the value of purchases made on a first customer device 108 by the customer 106 may be stored in the cloud-based resource as “customerX→firstdevice→totalPurchaseValue”. A second customer device 108 associated with the customer 106 may then read the cloud value and be able to calculate a total value of purchases by using the aggregate value from the first customer device 108. The second customer device 108 may then combine the aggregate value associated with the first customer device 108 with the summed value stored in its own event data. The second customer device 108 may also write its local totalPurchaseValue to the cloud-based resource for the benefit of the first customer device 108. The data sent to the cloud-based resource may include the raw application data 114, the event data 120, which may include the data events 208 of interest, an average, a maximum, a minimum, a standard deviation, and so on. Accordingly, by use of the cloud-based resource that is accessible to multiple customer devices 108 of the customer 106, each customer device 108 may determine the total/aggregate number of a particular data event 208 that was performed using the customer devices 108 of the customer 106. The total/aggregate number of the data event 208 may or may not be transmitted to the content server(s) 104.

Alternatively, or in addition, an array 306 associated with one of the multiple customer devices 108 of the customer 106 may store data events 308 responsive to the query 118 for the multiple customer devices 108. Or, the array 306 may be hosted by the content server(s) 104 or a different device. In any case, the array 306 may indicate the number of data events 308 associated with each of the multiple customer devices 108 of the customer 106. Since the data events 308 are associated with a customer device identifier and/or a customer identifier, it may be determined whether the aggregate total number of data events 308 associated with the multiple customer devices 108 satisfies the query criteria 302 associated with the query 118. If so, the data events 308 for the multiple customer devices 108 may be sent to the content server(s) 104 as event data 120.

The service provide 102 may elect to take various actions based on the event data 120 provided by the customer device(s) 108. For instance, if it is determined from the event data 120 that customers 106 prefer to take a particular action (e.g., place “Willow” in the dungeon), the service provider 102 may modify the application 112 such that the action can take place at a higher frequency. The service provider 102 may do this for customers 106 associated with the data events 308, but not for other customers 106 that did not perform an action associated with the data events 308. Moreover, if it is determined that customers 106 are not performing a particular action (e.g., not placing “Willow” in the dungeon), the service provider 102 may modify the application 112 so that this option is not presented to customers 106, or that the option is presented to customers 106 at a lower frequency. In other embodiments, the service provider 102 may elect to display advertisements within the application 112 where customers 106 tend to perform a certain action. Accordingly, based on data events 308 provided by customer devices 108 that include/store the application 112, which may represent customer interaction with the application 112, the service provide 102 may determine/infer preferences and/or interests of customers 106 with respect to the application 112. The service provider 102 may then modify the application 112 based on the interests/preferences of the customers 106. In some embodiments, modifications to the application 112 may be made for some customers 106/customer devices 108, but not others.

Although the application data 114 associated with the application 112 may be stored in memory of the customer device 108 in an optimized binary format, the amount/volume of application data 114 stored by the customer device 108 may become significant over time as the customer 106 continues to use/interact with the application 112. Accordingly, the customer device 108 may periodically determine which portions of the application data 114 should remain in memory, and which portions of the application data 114 should be discarded. This process may be referred to as garbage collection. Application data 114 that are to be kept may be associated with a priority or flag so that such application data 114 is not discarded. An algorithm may be configured to determine which application data 114 is to be saved/deleted, which may be based on one or more rules specified by the content server(s) 104, the customer device 108, and/or the application 112. That is, garbage collection may constitute automatic memory management of the customer device 108, where the algorithm/garbage collector attempts to reclaim memory occupied by application data 114 that is no longer in use by the service provider 102, the content server(s) 104, the customer device 108, and/or the application 112. Memory may be reclaimed by deleting/discarding certain portions of the application data 114, which may include data events 308 that are not of interest to the service provider 102. Portions of the application data 114 may also be compressed or re-compressed in order to allow for additional, subsequent application data 114 to be recorded and saved.

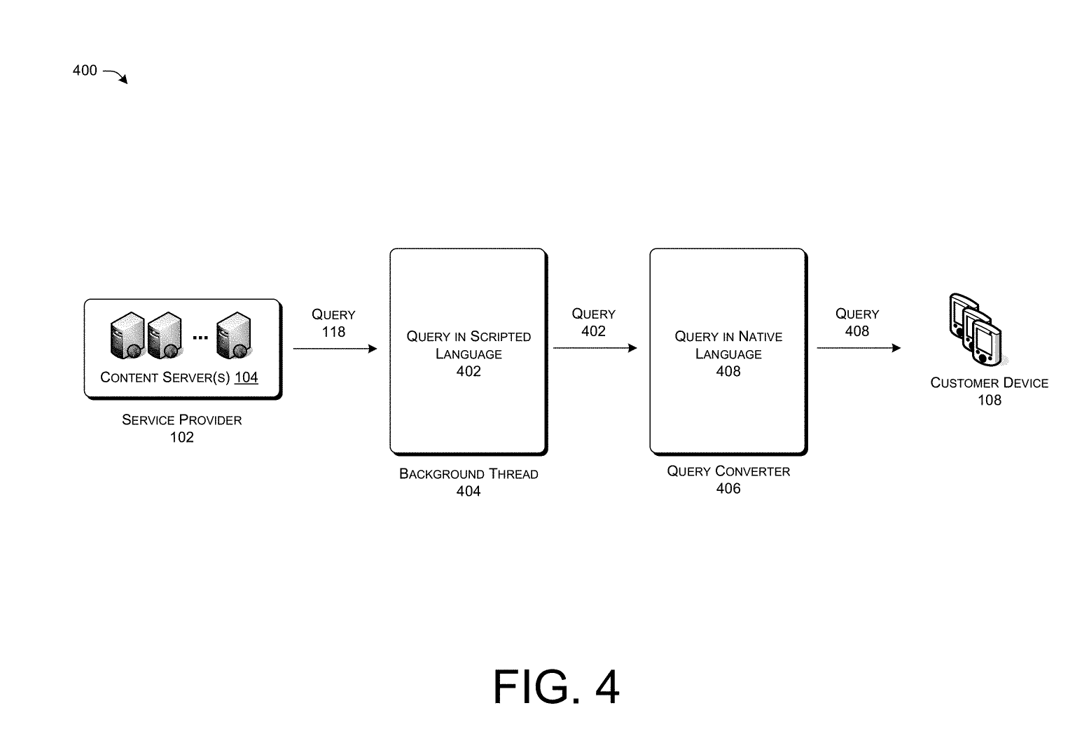

FIG. 4 illustrates an example diagram 400 for transmitting a query associated with an application to a customer device. As shown, the diagram 400 may include the content server(s) 104 associated with the service provider 102 and a customer device 108 associated with a customer 106. In various embodiments, the content server(s) 104 may generate and/or transmit a query 118 that is intended to be received by the customer device 108, where the query 118 includes query criteria 302 relating to customer interaction with the application 112. The query 118 may be written in a scripted/scripting language, which may be referred to as a programming language that supports scripts, or programs written for a particular run-time environment that automates the execution of certain tasks/operations. Although any type of scripted language may be used, the query 118 may take the form of JavaScript. For the purposes of FIG. 4, the query 118 may be referred to as the query in scripted language 402. Using the example described herein, the query in scripted language 402 may be “Willow in dungeon in the last 30 days.” The query in scripted language 402 may run as a background thread 404 on the customer device 108.

A bridge layer, or a query converter 406, may convert the query in scripted language 402 to a query in native language 408. The query 118 may be converted to a native language associated with the customer device 108 so that the customer device 108 may analyze the query 118 and identify data events 308 that are responsive to the query 118. In some embodiments, the native language may correspond to the C programming language, the Objective C programming language (including Objective C/C), the C# programming language, and/or the Java programming language. In particular, the query 118 may be bridged from JavaScript to the native language associated with the customer device 108. In various embodiments, the query converter 406/bridge layer may be situated on the content server(s) 104, the customer device 108, or a different device. Upon receiving the query 408 and after determining data events 308 that are responsive to the query 408, the customer device 108 may transmit the event data 120 to the content server(s) 104 via the network(s) 110.

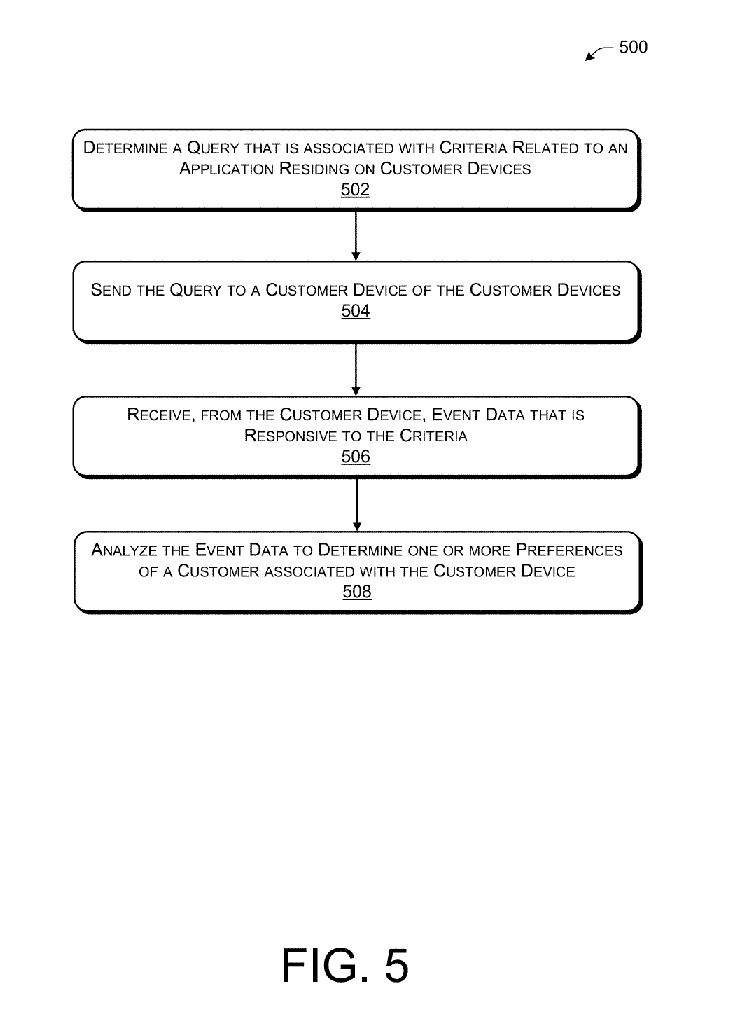

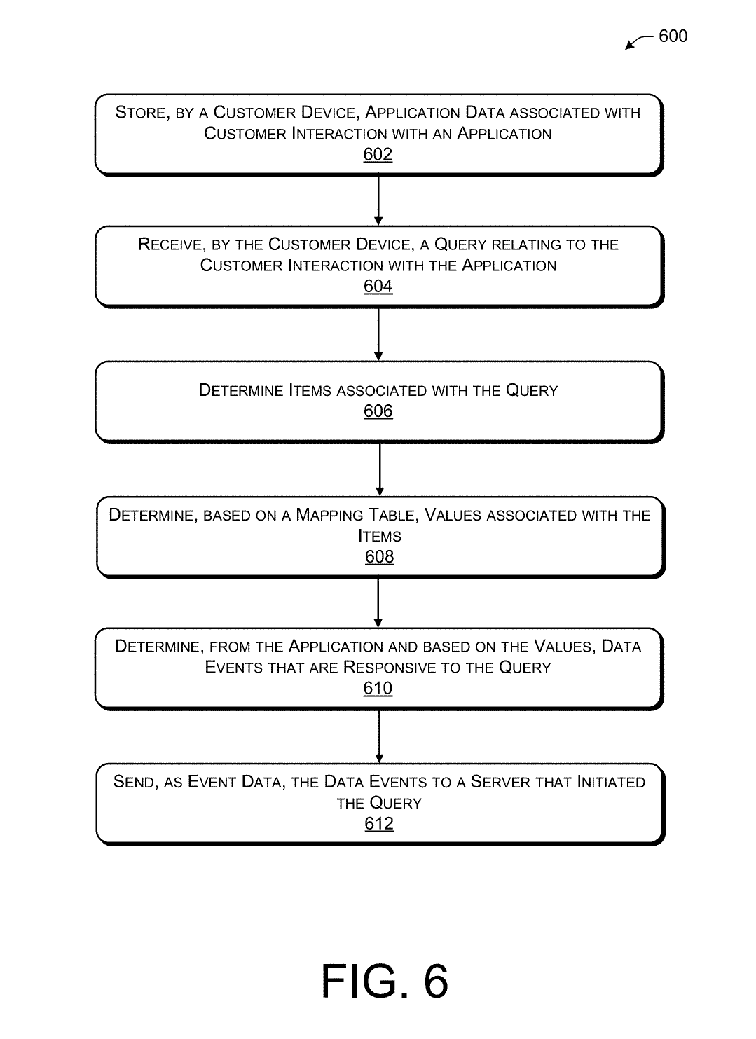

FIGS. 5 and 6 describe various example processes of determining event data associated with customer interaction with an application via a customer device. The example processes are described in the context of the environment of FIGS. 1-4 but are not limited to those environments. The order in which the operations are described in each example method is not intended to be construed as a limitation, and any number of the described blocks can be combined in any order and/or in parallel to implement each method. Moreover, the blocks in FIGS. 5 and 6 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 5 is a flow diagram illustrating an example process 500 of determining a query for event data associated with an application and receiving the event data from a customer device. Moreover, the following actions described with respect to FIG. 5 may be performed by the content server(s) 104 and/or the customer device(s) 108, as shown in FIGS. 1-4.

Block 502 illustrates determining a query associated with criteria related to an application residing on customer devices. In particular, customer devices 108 may store or include an application 112/game that is associated with the service provider 102. For instance, the service provider 102 may offer the application 112/game for download/installation on customer devices 108 of customers 106. The service provider 102 may desire to obtain information about how customers 106 are interacting with the application 112. Instead of receiving all data relating to customer interaction with the application 112 (e.g., application data 114), the service provider 102 may instead request specific information from customer devices 108. To do so, the content server(s) 104 of the service provider 102 may generate and transmit a query 118 to customer devices 108, where the query 118 may include query criteria 302 that specifies information that the query 118 is requesting. For instance, the query criteria 302 may constitute conditions that need to be satisfied in order for application data 114 stored on the customer devices 108 to be included as event data 120 that is responsive to the query 118 and that is to be transmitted from the customer devices 108 to the content server(s) 104.

Block 504 illustrates sending the query to a customer device of the customer devices. In various embodiments, the content server(s) 104 may send the query 118 to one or more customer devices 108 via the network(s) 110.

Block 506 illustrates receiving, from the customer device, event data that is responsive to the criteria. In various embodiments, the customer device 108 may determine whether the application data 114 stored thereon includes data events 308 that satisfy the criteria, where each data event 308 corresponds to a customer interaction with respect to the application 112. Provided that one or more data events 308 are identified, the customer device 108 may send those data events 308 (or summary information/data corresponding to those data events 308) to the content server(s) 104 via the network(s) 110 as event data 120.

Block 508 illustrates analyzing the event data to determine one or more preferences of a customer associated with the customer device. Based on the event data 120, the content server(s) 104 may determine actions performed by customers 106, which may indicate items/features that the customers 106 liked/preferred, disliked, etc. In some embodiments, based on the preferences/interests of customers 106 that are inferred from the event data 120, the service provider 102 may elect to modify the application 112/game. In some embodiments, the modification to the application 112/game or the advertisement presented to the customer via the application 112 may be occur on the customer device 108 itself. That is, the modification/advertisement may be performed with respect to the application 112 as a result of the customer device 108 receiving the query 118 from the content server(s) 104. For instance, the query 118 may communicate its result directly with the application 112 residing on the customer device 104. The query 118 may also send data back to the content server(s) 104 such that the content server(s) 104 may alter behavior on the customer device 108.

FIG. 6 is a flow diagram illustrating an example process 600 of determining data events that are associated with an application and that are responsive to a query initiated by a server. Moreover, the following actions described with respect to FIG. 6 may be performed by the content server(s) 104 and/or the customer device(s) 108, as shown in FIGS. 1-4.

Block 602 illustrates storing, by a customer device, application data associated with customer interaction with an application. In various embodiments, a customer device 108 of a customer 106 may store application data 114 associated with an application 112 stored thereon. Individual portions of the application data 114 (e.g., data events 208) may represent customer interaction with the application 112. For instance, using the example described throughout this disclosure, a portion of the application data 114 may represent the customer 106 performing a particular operation/action with respect to the application 112, such as placing the character “Willow” into the dungeon.

Block 604 illustrates receiving, by the customer device, a query relating to the customer interaction with the application. More particularly, a service provider 102 that is associated with the application 112 may desire to obtain information relating to how, and the extent to which, customers 106 are interacting with the application 112. As a result, the content server(s) 104 of the service provider 102 may generate a query 118 that is to be transmitted to the customer device 108. The query 118 may include query criteria 302 that specifies data events 308 that are to be transmitted to the content server(s) 104.

Block 606 illustrates determining items associated with the query. In certain embodiments, the customer device 108 may determine items, features, etc. (e.g., characters, levels, scenes, etc.) from the query 118 and/or the query criteria 302. The items/features may correspond to the type of customer interactions with the application 112 that are being requested by the service provider 102. For instance, using the example above, the items may include the character “Willow” and/or the term “dungeon”.

Block 608 illustrates determining, based on a mapping table, values associated with the items. In some embodiments, the computing device 108 may apply a hash function with respect to the items in order to obtain numerical values for the items. The mapping table 206 may include multiple items associated with the application 112, and a different value that is associated with each of the items.

Block 610 illustrates determining, from the application and based on the values, data events that are responsive to the query. The customer device 108 may search the application data 114 stored thereon in order to determine data events 308 that are responsive to the query 118. Those data events 308 may correspond to incidents, customer interactions, operations, etc., that satisfy the query criteria 302 associated with the query 118. The data events 308 that are responsive to the query 118 may be included in an array 306 maintained by the customer device 108.

Block 612 illustrates sending, as event data, the data events to a server that initiated the query. Upon determining the data events 308 that are responsive to the query 118, the customer device 108 may transmit, via the network(s) 110, the event data 120, which includes the previously identified data events 308. In other embodiments, the customer device 108 may transmit the event data 120 without first receiving a query 118 from the content server(s) 104.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
a server device that is configured to:
determine data to be obtained from multiple customer devices, the data being associated with an application that resides on each of the multiple customer devices;
generate, based at least partly on the data, a query that includes at least one query criteria; and
transmit the query to each of the multiple customer devices via a network; and
a customer device of the multiple customer devices that is configured to:
store, in memory of the customer device, application data that represents customer interaction with the application via the customer device;
receive, from the server device, the query;
determine that one or more data events included in the application data satisfy the at least one criteria; and
transmit, to the server device and via the network, at least one of the one or more data events or summary data that corresponds to the one or more data events.

2. The system as recited in claim 1, wherein a data event of the one or more data events is associated with an event identifier that uniquely identifies the data event, a timestamp associated with the data event, a numerical value that represents an item associated with the data event, and metadata that indicates a payload associated with the data event.

3. The system as recited in claim 1, wherein the server device is further configured to:
receive, from the customer device, the at least one of the one or more data events or the summary data;
determine, based at least partly on the at least one of the one or more data events or the summary data, at least one of a preference or an interest of a customer associated with the customer device with respect to the application; and
modify the application with respect to the customer based at least partly on the at least one of the preference or the interest of the customer.

4. The system as recited in claim 1, wherein the customer device is further configured to:
determine a first item and a second item associated with the application;
apply a hash function to the first item to generate a first numerical value;
apply the hash function to the second item to generate a second numerical value; and
associate, in a mapping table stored by the customer device, the first item with the first numerical value and the second item with the second numerical value.

5. The system as recited in claim 4, wherein the customer device is further configured to:
determine that the at least one query criteria includes the first item;
associate, in a query criteria filter maintained by the customer device, the first numerical value associated with the first item with the at least one query criteria; and
identify a data event of the one or more data events based at least partly on the first numerical value associated with the first item.

6. The system as recited in claim 1, wherein the customer device is further configured to generate an array that includes the one or more data events, the array indicating at least one of a number or a summation of the one or more data events.

7. The system as recited in claim 1, wherein the application is a game and the one or more data events represent customer interaction with at least one of a character, a scene, or a level associated with the game.

8. The system as recited in claim 1, wherein the customer device is associated with a customer and the one or more data events are associated with a customer identifier of the customer, and wherein the server device is further configured to:
receive, from a second customer device associated with the customer, one or more second data events associated with the application that also resides on the second customer device, the one or more second data events being associated with the customer identifier;
aggregate, based at least partly on the customer identifier, the one or more data events and the one or more second data events to generate aggregated data events; and
determine, based at least partly on the aggregated data events, an extent of customer interaction with the application by the customer.

9. The system as recited in claim 1, wherein the one or more data events include some, but not all, of the application data.

10. A method comprising:
determining, by a server device, data to be obtained from a customer device, the data being associated with an application that resides on the customer device;
generating, based at least partly on the data, a query that includes at least one query criteria, the at least one query criteria specifying conditions that are to be satisfied in order to constitute the data;
transmitting the query to the customer device via a network; and
at least one of:
receiving, from the customer device, at least one of one or more data events that are responsive to the query or summary data that corresponds to the one or more data events, the one or more data events including some, but not all, of application data that is associated with the application and that is stored by the customer device; or
performing an operation associated with the application with respect to the customer device.

11. The method as recited in claim 10, further comprising determining, based at least partly on the one or more data events, at least one of an interest or a preference of a customer associated with the customer device with respect to the application.

12. The method as recited in claim 11, wherein performing the operation comprises at least one of modifying or customizing the application with respect to the customer device based at least partly on the at least one of the interest or the preference of the customer.

13. The method as recited in claim 10, wherein the one or more data events are associated with a customer identifier of the customer, and further comprising:
receiving, from a second customer device associated with the customer, one or more second data events associated with the application that also resides on the second customer device, the one or more second data events being associated with the customer identifier;
aggregating, based at least partly on the customer identifier, the one or more data events and the one or more second data events to generate aggregated data events; and
determining, based at least partly on the aggregated data events, an extent of customer interaction with the application by the customer.

14. A device comprising:
one or more processors;
memory;
an application; and
one or more computer-executable instructions that are stored in the memory and that are executable by the one or more processors to perform operations comprising:
storing, in the memory, application data that represents customer interaction with the application;
receiving, from a server device, a query that includes at least one query criteria;
determining one or more data events included in the application data that satisfy the at least one query criteria, the one or more data events including some, but not all, of the application data; and
at least one of:
transmitting, to the server device and via a network, at least one of the one or more data events or summary data that corresponds to the one or more data events; or
determining a modification to the application with respect to the customer device.

15. The system as recited in claim 14, wherein a data event of the one or more data events includes an event identifier that uniquely identifies the data event, a timestamp associated with the data event, a numerical value that represents an item associated with the data event, and metadata that indicates a payload associated with the data event.

16. The system as recited in claim 14, wherein the application is a game and the one or more data events represent customer interaction with at least one of a character, a scene, or a level associated with the game.

17. The system as recited in claim 14, wherein the operations further comprise:
determining a first item and a second item associated with the application;
applying a hash function to the first item to generate a first numerical value;
apply the hash function to the second item to generate a second numerical value; and
associate, in a mapping table stored in the memory, the first item with the first numerical value and the second item with the second numerical value.

18. The system as recited in claim 17, wherein the operations further comprise:
determining that the at least one query criteria includes the first item;
associating, in a query criteria filter maintained by the device, the first numerical value associated with the first item with the at least one query criteria; and
identifying a data event of the one or more data events based at least partly on the first numerical value associated with the first item.

19. The system as recited in claim 14, wherein the operations further comprise generating an array that includes the one or more data events, the array indicating at least one of a number or a summation of the one or more data events.

20. The system as recited in claim 14, wherein the query is in a scripted programming language, and wherein the operations further comprise:
converting the query in the scripted programming language to a query in a native programming language; and
determining the one or more data events based at least partly on the query in the native programming language.
